(19) United States
(12) Patent Application Publication
(10) Pub. No.: US 2025/0390657 A1
(43) Pub. Date: Dec. 25, 2025

(54) DYNAMIC INTERCONNECT RECONFIGURATION

(71) Applicants: Advanced Micro Devices, Inc., Santa Clara, CA (US); ATI Technologies ULC, Markham (CA)

(72) Inventors: Matthew Schoenwald, Fort Collins, CO (US); Kevin M. Lepak, Austin, TX (US); YanFeng Wang, Markham (CA)

(73) Assignees: Advanced Micro Devices, Inc., Santa Clara, CA (US); ATI Technologies ULC, Markham, ON (CA)

(21) Appl. No.: 18/750,929

(22) Filed: Jun. 21, 2024

(51) Int. Cl. G06F 30/347; G06F 30/392; G06F 115/02

(52) U.S. Cl. CPC G06F 30/347; G06F 30/392; G06F 2115/02

(57) ABSTRACT

The disclosed device can dynamically reassign wires of an interconnect among channels for more efficient utilization. If a first channel is over-utilized and one or more other channels are under-utilized, the device can dynamically temporarily reassign wires of the under-utilized channels to the over-utilized channel to increase throughput. Various other methods, systems, and computer-readable media are also disclosed.

### BACKGROUND

System-on-chip (SOC) and other processor architectures often utilize different chiplets, cores, or processing units that can independently perform operations. For example, each chiplet can perform its own set of operations with respective sets of data. Such architectures allow improved overall processing performance by allowing more parallel processing of tasks.

The chiplets often communicate with each other by sending/accessing data through interconnects that couple the chiplets. For example, the chiplets can coordinate on performing larger tasks, or the chiplets can be configured for specialized tasks. Interconnects often include a limited set of wires that can be restricted due to physical space and/or design considerations as well as fabrication considerations. An interconnect can be separated into channels that are reserved for communication between particular chiplets/components. However, the channel usage can be inefficient.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an exemplary system for dynamic interconnect reconfiguration.

FIG. 2 is a block diagram of an exemplary interconnect arrangement between chiplets.

FIGS. 3A-C are diagrams of channel reconfigurations.

FIG. 4 is a flow diagram of an exemplary method for dynamic interconnect reconfiguration.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the present disclosure covers all modifications, equivalents, and alternatives falling within the scope of the appended claims.

### DETAILED DESCRIPTION

The present disclosure is generally directed to optimizing interconnect utilization by dynamically reconfiguring channels. As will be explained in greater detail below, implementations of the present disclosure can detect an imbalance between bandwidth of various channels of an interconnect and reassign wires of an idle channel to increase throughput of a busy channel. The systems and methods described herein advantageously improves the observed bandwidth of a channel without requiring significant architectural changes.

Features from any of the implementations described herein can be used in combination with one another in accordance with the general principles described herein. These and other implementations, features, and advantages will be more fully understood upon reading the following detailed description in conjunction with the accompanying drawings and claims.

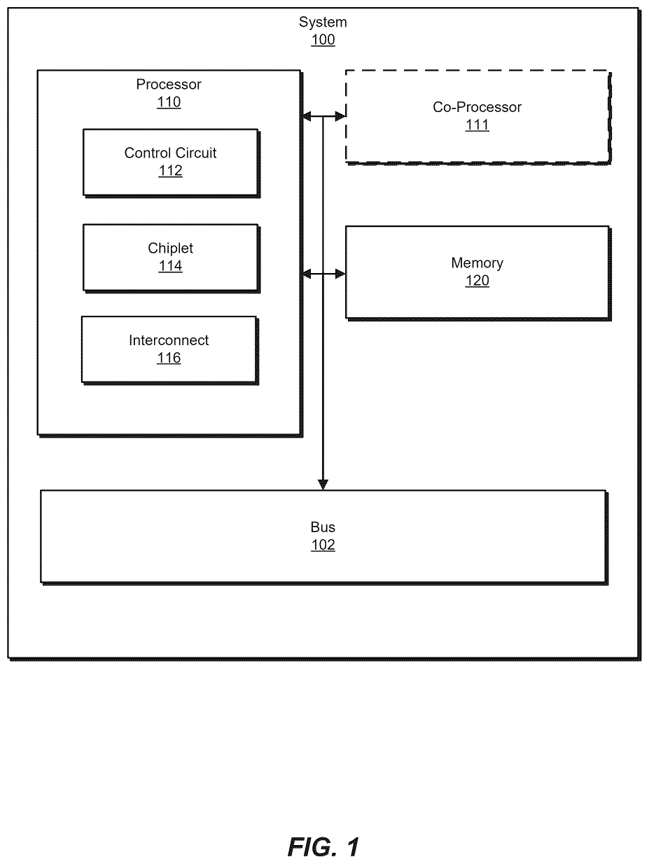

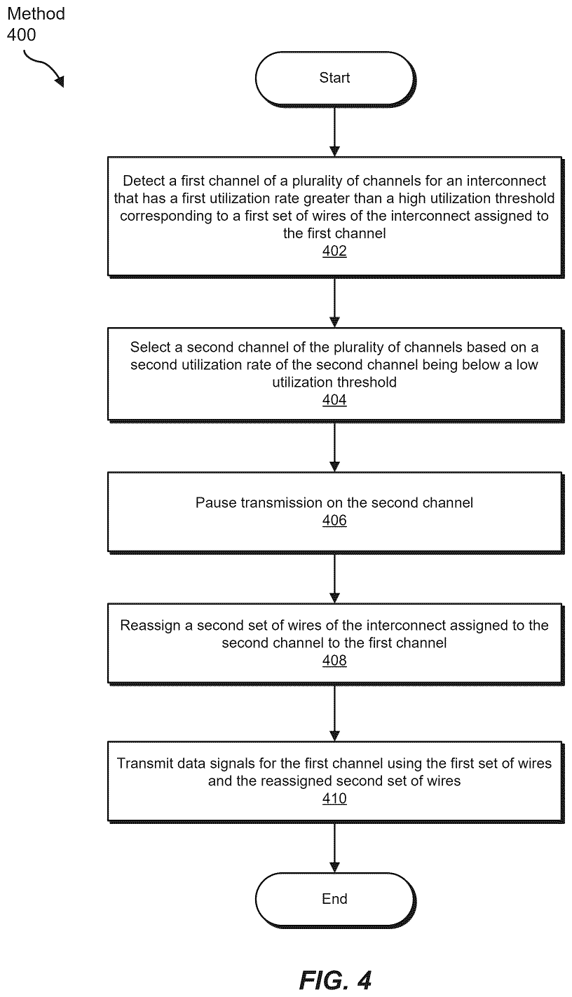

The following will provide, with reference to FIGS. 1-4, detailed descriptions of dynamic interconnect reconfiguration. Detailed descriptions of example systems and devices will be provided in connection with FIGS. 1-3C. Detailed descriptions of corresponding computer-implemented methods will also be provided in connection with FIG. 4.

FIG. 1 is a block diagram of an example system 100 for dynamic interconnect reconfiguration. System 100 corresponds to a computing device, such as a desktop computer, a laptop computer, a server, a tablet device, a mobile device, a smartphone, a wearable device, an augmented reality device, a virtual reality device, a network device, and/or an electronic device. As illustrated in FIG. 1, system 100 includes one or more memory devices, such as memory 120. Memory 120 generally represents any type or form of volatile or non-volatile storage device or medium capable of storing data and/or computer-readable instructions. Examples of memory 120 include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, and/or any other suitable storage memory.

As illustrated in FIG. 1, example system 100 includes one or more physical processors, such as processor 110, which can correspond to one or more processors (e.g., a host processor along with a co-processor, which in some examples can be separate processors). Processor 110 generally represents any type or form of hardware-implemented processing unit capable of interpreting and/or executing computer-readable instructions. In some examples, processor 110 accesses and/or modifies data and/or instructions stored in memory 120. Examples of processor 110 include, without limitation, one or more instances of chiplets (e.g., smaller and in some examples more specialized processing units that can coordinate as a single chip), microprocessors, microcontrollers, Central Processing Units (CPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, accelerated processing units (APUs), portions of one or more of the same, variations or combinations of one or more of the same (e.g., a host processor and a co-processor), and/or any other suitable physical processor(s). Further, in some examples, processor 110 can be a general-purpose processor that can be capable, without significant limitation, of various computing tasks, as opposed to a special purpose processor that can be limited in computing tasks (e.g., specially designed for particular computing tasks such as moving data, performing certain mathematical operations, etc.), although in other examples processor 110 can correspond to and/or incorporate one or more special purpose processors.

As also illustrated in FIG. 1, example system 100 can in some implementations optionally include one or more physical co-processors, such as co-processor 111, which in other implementations can be integrated with or otherwise represented by processor 110. Co-processor 111 generally represents any type or form of hardware-implemented processing unit capable of interpreting and/or executing computer-readable instructions, which in some examples works in conjunction and/or based on instructions from a host/main processor such as a CPU (e.g., processor 110). In some examples, co-processor 111 accesses and/or modifies data and/or instructions stored in memory 120. Examples of co-processor 111 include, without limitation, chiplets (e.g., smaller and in some examples more specialized processing units that can coordinate as a single chip), microprocessors, microcontrollers, graphics processing units (GPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, accelerated processing units (APUs), portions of one or more of the same, variations or combinations of one or more of the same, and/or any other suitable physical processor.

FIG. 1 also includes a bus 102 that can correspond to any bus, circuitry, connections, and/or any other communicative pathways for sending communicative signals, based on one or more communication protocols, between components/devices (e.g., processor 110, memory 120, and/or co-processor 111, etc.). In some implementations, bus 102 can further connect, via wireless and/or wired connections, to other devices, such as peripheral devices external to or partially integrated with system 100. Although not illustrated in FIG. 1, in some implementations, system 100 can be coupled to a display device (e.g., via bus 102).

As further illustrated in FIG. 1, processor 110 includes a control circuit 112, a chiplet 114, and an interconnect 116. Control circuit 112 corresponds to one or more circuits/circuitry, such as a driver circuit, for coordinating or otherwise managing signals sent across an interconnect such as interconnect 116. Chiplet 114 represents one or more chiplets and/or dies of processor 110. Interconnect 116 corresponds to a physical communication connection between components (e.g., one or more chiplet 114) that can include multiple wires (e.g., each corresponding to conductive paths such as traces, patterned metallic/conductive material, etc. for sending its own signal) along with additional connections as needed, such as electrodes/contacts, bumps, traces, vias, etc. As will be described further below, interconnect 116 can include wires that are reserved for different channels that are managed by control circuit 112.

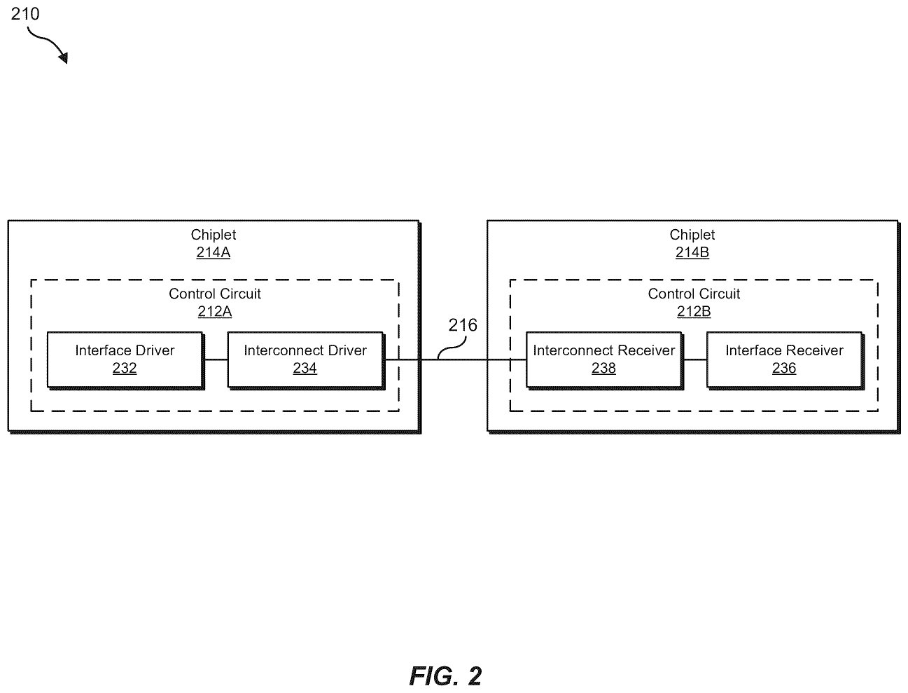

FIG. 2 illustrates a device 210 corresponding to processor 110. FIG. 2 includes a chiplet 214A and a chiplet 214B (each corresponding to separate instances of chiplet 114) having a respective control circuit 212A and control circuit 212B (each corresponding to separate instances of control circuit 112). Chiplet 214A and chiplet 214B can be communicatively coupled with an interconnect 216 (corresponding to interconnect 116).

As further illustrated in FIG. 2, control circuit 212A includes an interface driver 232 and an interconnect driver 234, and control circuit 212B includes an interconnect receiver 238 and an interface receiver 236. FIG. 2 illustrates chiplet 214A as sending data/signals to chiplet 214B, although in other examples chiplet 214B can also send data/signals to chiplet 214B.

Interconnect driver 234 and interconnect receiver 238 each correspond to interconnect controllers, representing a lowest level of an interconnect communication protocol (e.g., closest to a physical layer such as a physical interface), for sending/receiving a particular signal across a particular wire of interconnect 216 as directed by an interface controller such as interface driver 232 and/or interface receiver 236. Interface driver 232 and interface receiver 236 each correspond to interface controllers (e.g., a logical interface) that can schedule or otherwise assign which signals are sent/received on which wires, and can further maintain which wires are mapped or otherwise reserved for which channels. A channel can correspond to a data path between particular components of a processor/chiplet, such as local storage devices, functional/logic units, etc. As will be described further below, wires can be reserved for channels to ensure routing of signals between components.

In FIG. 2, interface driver 232 can receive data from components of chiplet 214A for sending to components of chiplet 214B. Interface driver 232 can track which wires of interconnect 216 correspond to which channels (e.g., using a routing table or other structure), such that a signal along a particular wire can be attributed/assigned to a particular channel, which can correspond to a particular source and destination. Interface driver 232 can further manage when to send data/signals. For example, interface driver 232 can queue data when the corresponding channel is unavailable (e.g., sending data on a current/future cycle). At each cycle, interface driver 232 can manage what queued data is sent along which wires and instruct interconnect driver 234 accordingly. Interconnect receiver 238 can receive the signals from the wires, and interface receiver 236 can route the data based on the channels mapped to the wires.

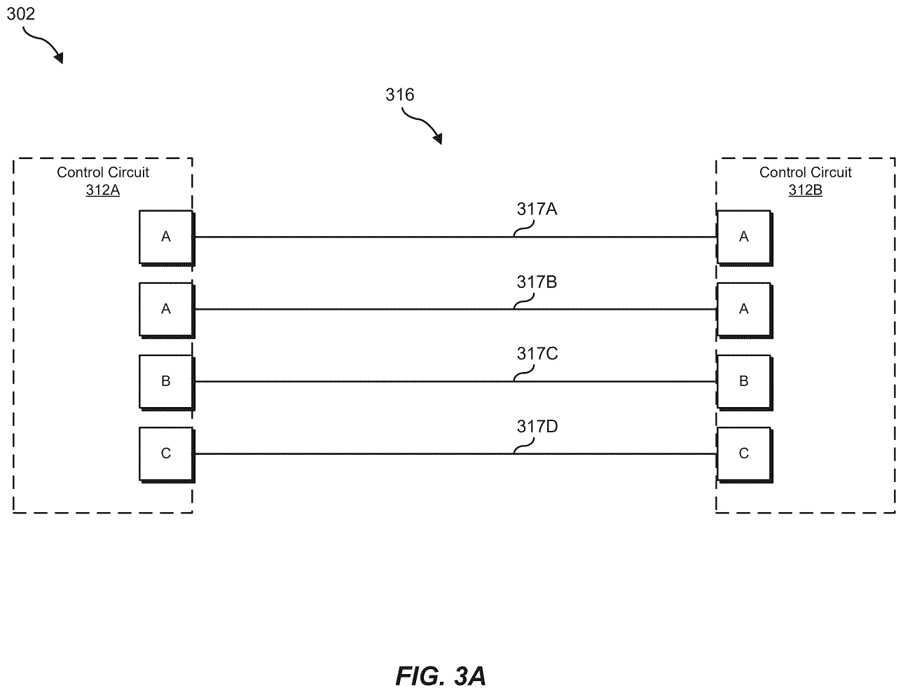

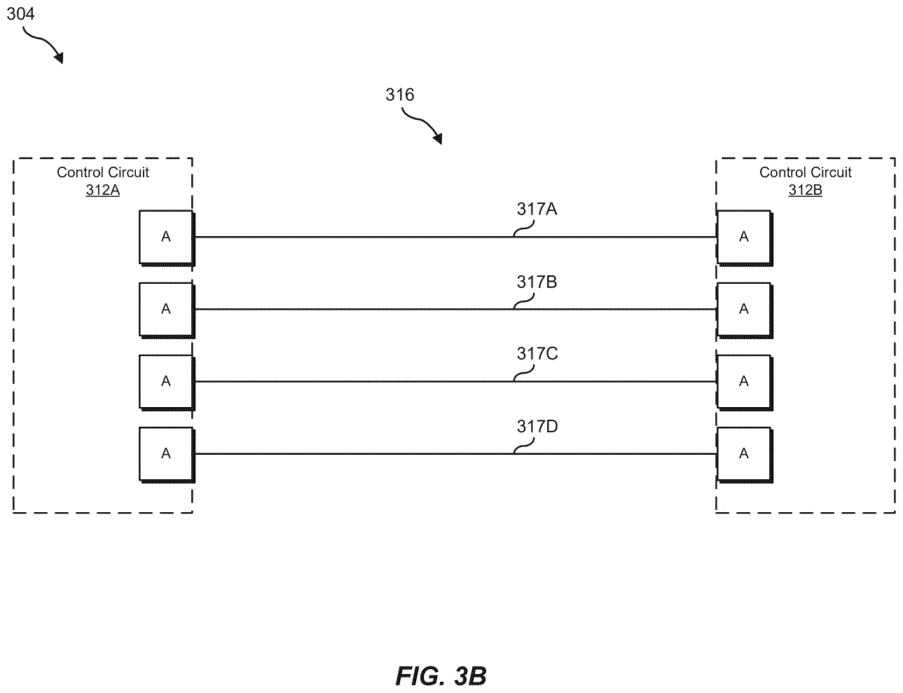

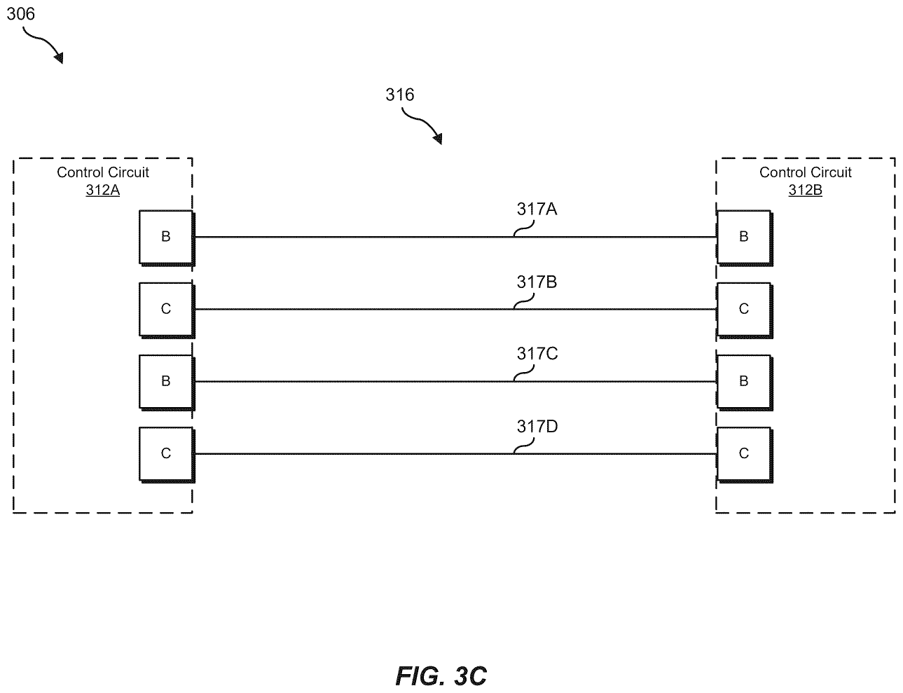

FIGS. 3A-3C further illustrate diagrams of channels as described herein. FIG. 3A illustrates a configuration 302 for a control circuit 312A (corresponding to control circuit 212A) and a control circuit 312B (corresponding to control circuit 212B) that are coupled with an interconnect 316 (corresponding to interconnect 216). FIG. 3A illustrates an example of interconnect 316 having four wires, a wire 317A, a wire 317B, a wire 317C, and a wire 317D, although in other examples a different number of wires can be used, and different interconnects can have a same or different number of wires within a given system/device. Further, each wire can correspond to a single signal (e.g., a single bit), although in other examples can represent other bit combinations.

In FIG. 3A, wire 317A and wire 317B can be mapped to channel A, wire 317C can be mapped to channel B, and wire 317D can be mapped to channel C, although in other examples greater or fewer channels can be used. Thus, for any given cycle, interconnect 316 can send 2 bits for channel A, 1 bit for channel B, and 1 bit for channel C. In addition, for any given cycle, if a greater number of bits/data signals need to be sent in a channel than wires assigned to the channel, control circuit 312A (e.g., an interface driver of control circuit 312A) can queue the excess bits for sending at a later cycle. For instance, sending 4 bits on channel A can take 2 cycles, sending 2 bits on channel B can take 2 cycles, sending 4 bits on channel C can take 4 cycles, and so forth.

Using all the wires of interconnect 316 for a given cycle maximizes how much data can be sent. However, the channel assignments can present sub-optimal usage of interconnect 316 in some scenarios. For example, channel A can have 4 bits to send, and channels B and C have 0 bits. In this scenario, two cycles are required for sending the data for channel A, with interconnect 316 being only half utilized during both cycles.

If, in this particular scenario, the wires were reassigned (e.g., remapped or otherwise changing an original assignment) from idle channels B and C to channel A (as in configuration 304 depicted in FIG. 3B), the 4 bits can be efficiently sent in 1 cycle. In FIG. 3B, control circuit 312A can detect utilization rates (e.g., corresponding to how many assigned wires are used each cycle for sending data and/or a rate of filling/emptying a related data queue), such as detecting that channel A is overutilized, having more data signals/bits that can be sent in a single cycle (e.g., based on a default number of wires originally assigned to channel A as illustrated in FIG. 3A), for instance by queueing data, and scheduling the data to be sent over multiple cycles. In other examples, control circuit 312A can detect a high utilization rate for channel A based on one or more performance metrics, such as exceeding a high utilization threshold that can correspond to a number/percent of wires of the channel used for recent window of cycles, a size of a data queue for queuing data for the channel exceeding a data queue threshold, temperature and/or power consumption for the wires/interconnect exceeding a corresponding threshold, heavy workload, etc.

Control circuit 312A can further detect another channel that is idle or under-utilized, for instance by detecting no queued data to be sent or by other performance metrics (e.g., being below a low utilization threshold, a size of a data queue for queuing data for the channel being below a data queue threshold, temperature and/or power consumption for the wires/interconnect being below a corresponding threshold, low workload, etc.). By dynamically reassigning wires from the under-utilized channel to the overutilized channel, control circuit 312A can more efficiently utilize interconnect 316. In other words, control circuit 312A can identify over-utilized channels and under-utilized channels and dynamically reassign as many available wires from the under-utilized channels to over-utilized channels (e.g., until the over-utilized channels are no longer over-utilized and/or until no wires are available from under-utilized channels).

In some implementations, control circuit 312A can use other factors for selecting and reassigning wires to channels. For example, control circuit 312A can detect combined utilization rates of one or more channels being below a low utilization threshold, which can be a similar threshold as used for evaluating a single channel, or can be different. Thus, in FIG. 3B, control circuit 312A can detect both channel B and channel C being under-utilized, and reassign the corresponding wires (e.g., wire 317C and wire 317D) to channel A.

In some implementations, control circuit 312A can further dynamically reassign wires as needed, such as restoring the original/default configuration (e.g., configuration 302 in FIG. 3A) or changing to a different configuration (e.g., a configuration 306 in FIG. 3C as will be described further below). In some examples, control circuit 312A can apply various scheduling factors/schemes. For example, based on a utilization of channel A, control circuit 312A can pause transmissions (e.g., temporarily halting propagation of data signals for instance by queuing data in a related data queue as needed) on the reassigned channels (e.g., channel B and channel C). In some instances, control circuit 312A can aggressively apply the dynamic reconfiguration by pausing the other channels until channel A completes (e.g., empties its data queue). However, in other instances, such pausing can cause stalling issues with respect to the other channels, such that control circuit 312A can reassign one or more wires back to the other channels (e.g., wire 317C to channel B and/or wire 317D to channel C) as needed. Further, in some examples, control circuit 312A can be configured to minimize impact to the other channels such that the dynamic reconfiguration can be applied more conservatively (e.g., only when the channel is idle). Reassigning the wires allows the other channels to resume transmissions (e.g., continue propagation of data signals, which can relate to starting with data previously queued when pausing transmission).

In some examples, control circuit 312A can further optimize reassignments, such as by interleaving transmissions of channels. For instance, control circuit 312A can reassign wires from channels B and C to channel A (as in FIG. 3B) to allow channel A to make progress. After a number of cycles, which can correspond to stalling in channels B and C (e.g., relating to how much data is queued for the respective channels), control circuit 312A can pause channel A and reassign wires to channels B and C, allowing more aggressive progress for channels B and C. FIG. 3C shows wires for channel A (e.g., wire 317A and wire 317B) reassigned to channels B and C, respectively, such that channels B and C can send double the amount of data per cycle as compared to FIG. 3A. Control circuit 312A can reconfigure interconnect 316 as needed (e.g., as in FIGS. 3A-3C). Alternatively, control circuit 312A can determine that based on the bandwidth requirements and/or utilization rates of channels B and C, that channels B and C can be coalesced (e.g., as in FIG. 3C) for a given number of cycles, leaving the remaining cycles fully available for channel A (e.g., as in FIG. 3B).

Accordingly, control circuit 312A can load balance the data queues of the channels by dynamically reconfiguring the wire assignments as described herein. In addition, control circuit 312A can reconfigure interconnect 316 in other combinations not shown in FIGS. 3A-3C. Further, in other implementations, interconnect 316 can include additional wires for additional channels such that control circuit 312A can similarly manage and dynamically reconfigure interconnect 316 in any possible combination/sub-combination of wires and channels as needed.

FIG. 4 is a flow diagram of an exemplary method 400 for dynamic interconnect reconfiguration. The steps shown in FIG. 4 can be performed by any suitable computer-executable code, computing system, and/or device including the system(s) illustrated in FIGS. 1, 2, and/or 3A-3C. In one example, each of the steps shown in FIG. 4 represent an algorithm whose structure includes and/or is represented by multiple sub-steps, examples of which will be provided in greater detail below.

As illustrated in FIG. 4, at step 402 one or more of the systems described herein detect a first channel of a plurality of channels for an interconnect that has a first utilization rate greater than a high utilization threshold corresponding to a first set of wires of the interconnect assigned to the first channel. For example, control circuit 112 can detect a channel of interconnect 116 being over-utilized.

The systems described herein can perform step 402 in a variety of ways. In one example, interface driver 232 can detect, based on one or more of the performance metrics described herein such as utilization rate, that a channel of interconnect 216 is over-utilized. For instance, control circuit 312A can detect that channel A of interconnect 316 has a utilization rate exceeding a high utilization threshold.

At step 404 one or more of the systems described herein select a second channel of the plurality of channels based on a second utilization rate of the second channel being below a low utilization threshold. For example, control circuit 112 can detect another channel of interconnect 116 being underutilized.

The systems described herein can perform step 404 in a variety of ways. In one example, interface driver 232 can select, based on one or more of the performance metrics described herein such as utilization rate, another channel of interconnect 216 that is underutilized. In further examples, control circuit 312A can select multiple channels that are underutilized, such as channels B and C of interconnect 316 having a combined utilization rate being below a low utilization threshold.

At step 406 one or more of the systems described herein pause transmission on the second channel. For example, control circuit 112 can pause transmission on the second channel, which can include queuing any incoming data on the second channel.

The systems described herein can perform step 406 in a variety of ways. In one example, interface driver 232 can pause the selected second channel of interconnect 216 such that the second channel can be guaranteed idle in a subsequent cycle. In further examples, control circuit 312A can pause multiple selected channels, such as channels B and C.

At step 408 one or more of the systems described herein reassign a second set of wires of the interconnect assigned to the second channel to the first channel. For example, control circuit 112 can reassign the wires of the second channel to the first channel.

The systems described herein can perform step 408 in a variety of ways. In one example, interface driver 232 can reassign the wires of interconnect 216 from the second channel to the first channel. In further examples, control circuit 312A can reassign the wires of multiple selected channels, such as wire 317C from channel B to channel A, and wire 317D from channel C to channel A.

At step 410 one or more of the systems described herein transmit data signals for the first channel using the first set of wires and the reassigned second set of wires. For example, control circuit 112 can transmit (e.g., driving or otherwise sending voltages/electrical signals across wires) bits for the first channel using the wires currently assigned to the first channel, which can include the wires originally assigned to the first channel, and the wires reassigned from the second channel.

The systems described herein can perform step 410 in a variety of ways. In one example, interface driver 232 can transmit data for the first channel using the wires of interconnect 216 as assigned to the first channel. In further examples, control circuit 312A can transmit data for channel A using the wires of multiple selected channels, such as wire 317C and wire 317D wire 317A and wire 317B.

Moreover, in some examples, control circuit 112 can resume transmission on the paused channel or channels. For example, control circuit 112 can assign wires back to the paused channel(s), which can include originally assigned wires and/or other available wires. As described herein, control circuit 112 can manage scheduling policies for dynamically reconfiguring interconnect 116.

As detailed above, in a multi-channel SOC interconnect, the channel usage can frequently be imbalanced. One channel can be over-utilized (e.g., Channel A) and others can be under-utilized (e.g., Channel B and C). In such a situation, the interface and/or interconnect controller can increase the throughput of Channel A by using wires typically used to transmit Channels B and C, as described herein.

The width of SOC interconnects is often highly constrained due to the low density of current package interconnect technology relative to silicon interconnect density. Thus, the width of the interconnect can be the limiter for the throughput achieved by the agents in the system. If the interconnect provides more throughput, the SOC could achieve higher performance. The systems and methods provided herein advantageously increases the effective throughput of a multi-channel SOC interconnect without increasing the physical width of the interconnect.

In an illustrative example, an interconnect can contain three channels: A, B, and C. Channel A contains X signals, but only X/2 wires are dedicated to it on the interconnect. Therefore, it requires 2 cycles to communicate a full packet across the interconnect on Channel A. Channels B and C combined require at least X/2 signals and have a dedicated wire for every signal. With the interface controller as described herein, if Channel B and C are both idle on a cycle where the interconnect driver is sending a new packet on Channel A, the interconnect driver may use the wires typically dedicated for Channels B and C to transmit a full Channel A packet across the interconnect in a single cycle, increasing the bandwidth achieved by Channel A with, in some implementations, a single additional wire to identify the situation, and no impact to the bandwidth achieved by Channels B and C.

The interface controller may make further optimizations. Under different circumstances, it can prioritize the bandwidth of Channel A by blocking Channel B and C so that Channel A can take advantage of the increased bandwidth. The interface controller can further choose to block Channel B if Channel C is idle, intending to only use Channel B when Channel C can be active as well. This optimization can, in some instances, increase the frequency of engaging the dynamic reconfiguration described herein, and thereby increasing the observed bandwidth of Channel A and the combined efficiency of Channels A, B, and C.

These advantages can be achieved without physically changing the interconnect allowing retrofitting onto existing physical interfaces. The systems and methods described herein further require less logical complexity (e.g., as compared to virtual channels), for instance by allowing channels of mismatched size to be combined together efficiently whereas virtual channels often require similar sized channels to achieve maximum efficiency.

In one implementation, a device for dynamic interconnect reconfiguration includes a control circuit configured to detect a first channel of a plurality of channels for an interconnect that has a greater number of data signals to send than a number of a first set of wires of the interconnect assigned to the first channel, reassign a second set of wires assigned to a second channel of the plurality of channels to the first channel, and transmit the data signals for the first channel using the first set of wires and the reassigned second set of wires.

In some examples, the control circuit is configured to select the second channel based on an idle status (e.g., having no or below a threshold number of signals to transmit or planned to transmit for a threshold number of cycles and/or other indication of being idle or under-utilized as described herein) of the second channel. In some examples, the control circuit is configured to select the second channel based on a utilization rate of the second channel being below a low utilization threshold.

In some examples, the control circuit is configured to pause transmission on the second channel. In some examples, the control circuit is configured to resume transmission on the second channel by reassigning the second set of wires back to the second channel. In some examples, the control circuit is configured to resume transmission on the second channel by reassigning the first set of wires to the second channel (e.g., to aggressively resume transmission on the second channel). In some examples, the control circuit is configured to resume transmission on the second channel based on scheduling factors.

In some examples, the control circuit is configured to reassign a third set of wires assigned to a third channel of the plurality of channels to the first channel, and transmit the data signals for the first channel using the first set of wires, the reassigned second set of wires, and the reassigned third set of wires. In some examples, the control circuit is configured to select the second and third channels based on a combined utilization rate of the second and third channels being below a low utilization threshold.

In one implementation, a system for dynamic interconnect reconfiguration includes a memory, and a processor comprising a first die and a second die, and an interconnect for communicatively coupling the first and second dies. In some examples, the interconnect includes a plurality of wires assigned to a plurality of channels. The processor further includes a control circuit configured to detect a first channel of the plurality of channels that has a greater number of data signals to send than a number of a first set of wires of the plurality of wires assigned to the first channel, select a second channel of the plurality of channels based on a utilization rate of the second channel being below a low utilization threshold, reassign a second set of wires of the plurality of wires assigned to a second channel to the first channel, and transmit the data signals for the first channel using the first set of wires and the reassigned second set of wires.

In some examples, the control circuit is configured to pause transmission on the second channel. In some examples, the control circuit is configured to resume transmission on the second channel by reassigning the second set of wires back to the second channel. In some examples, the control circuit is configured to resume transmission on the second channel by reassigning the first set of wires to the second channel. In some examples, the control circuit is configured to resume transmission on the second channel based on scheduling factors.

In some examples, the control circuit is configured to reassign a third set of wires of the plurality of wires assigned to a third channel of the plurality of channels to the first channel, and transmit the data signals for the first channel using the first set of wires, the reassigned second set of wires, and the reassigned third set of wires. In some examples, the control circuit is configured to select the second and third channels based on a combined utilization rate of the second and third channels being below a low utilization threshold.

In one implementation, a method for dynamic interconnect reconfiguration includes detecting a first channel of a plurality of channels for an interconnect that has a first utilization rate greater than a high utilization threshold corresponding to a first set of wires of the interconnect assigned to the first channel, selecting a second channel of the plurality of channels based on a second utilization rate of the second channel being below a low utilization threshold, pausing transmission on the second channel, reassigning a second set of wires of the interconnect assigned to the second channel to the first channel, and transmitting data signals for the first channel using the first set of wires and the reassigned second set of wires.

In some examples, the method further includes resuming transmission on the second channel by reassigning the second set of wires back to the second channel. In some examples, the method further includes resuming transmission on the second channel by reassigning the first set of wires to the second channel.

In some examples, the method further includes selecting the second channel and a third channel of the plurality of channels based on a combined utilization rate of the second and third channels being below a low utilization threshold, reassigning a third set of wires assigned to a third channel to the first channel, and transmitting the data signals for the first channel using the first set of wires, the reassigned second set of wires, and the reassigned third set of wires.

As detailed above, the computing devices and systems described and/or illustrated herein broadly represent any type or form of computing device or system capable of executing computer-readable instructions, such as those contained within the code/firmware/programs described herein. In their most basic configuration, these computing device(s) each include at least one memory device and at least one physical processor.

In some examples, the term “memory device” generally refers to any type or form of volatile or non-volatile storage device or medium capable of storing data and/or computer-readable instructions. In one example, a memory device stores, loads, and/or maintains one or more of the instructions and/or circuits described herein. Examples of memory devices include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, or any other suitable storage memory.

In some examples, the term “physical processor” generally refers to any type or form of hardware-implemented processing unit capable of interpreting and/or executing computer-readable instructions. In one example, a physical processor accesses and/or modifies one or more instructions stored in the above-described memory device. Examples of physical processors include, without limitation, chiplets (e.g., smaller and in some examples more specialized processing units that can coordinate as a single chip), microprocessors, microcontrollers, Central Processing Units (CPUs), Field-Programmable Gate Arrays (FPGAs) that implement softcore processors, Application-Specific Integrated Circuits (ASICs), systems on chip (SoCs), digital signal processors (DSPs), Neural Network Engines (NNEs), accelerators, accelerated processing units (APUs), portions of one or more of the same, variations or combinations of one or more of the same (e.g., a host processor and a co-processor), and/or any other suitable physical processor.

In some examples, the term “physical processor” also refers to and/or includes a co-processor that generally refers to any type or form of hardware-implemented processing unit capable of interpreting and/or executing computer-readable instructions, which in some examples works in conjunction with and/or based on instructions from a host/main processor such as a CPU, and further in some examples accesses and/or modifies one or more instructions stored in the above-described memory device. Examples of co-processors include, without limitation, chiplets, microprocessors, microcontrollers, graphics processing units (GPUs), FPGAS that implement softcore processors, ASICs, SoCs, DSPs, NNEs, accelerators, portions of one or more of the same, variations or combinations of one or more of the same, and/or any other suitable physical processor.

Although described as separate elements/steps, the instructions described and/or illustrated herein can represent portions of a single program or application, including instructions implemented in code, firmware, one or more circuits, etc. In addition, in certain implementations one or more of these instructions can represent one or more software applications or programs that, when executed by a computing device, cause the computing device to perform one or more tasks. For example, one or more of the instructions described and/or illustrated herein represent instructions stored and configured to run on one or more of the computing devices or systems described and/or illustrated herein. In some implementations, one or more instructions can be implemented as a circuit or circuitry, including as part of a firmware, a ROM, one or more logic units, etc. One or more of these instructions can also represent or otherwise be implemented with all or portions of one or more special-purpose computers configured to perform one or more tasks.

In some implementations, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein are shown or discussed in a particular order, these steps do not necessarily need to be performed in the order illustrated or discussed. The various exemplary methods described and/or illustrated herein can also omit one or more of the steps described or illustrated herein or include additional steps in addition to those disclosed.

The preceding description has been provided to enable others skilled in the art to best utilize various aspects of the exemplary implementations disclosed herein. This exemplary description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A device comprising:
a control circuit configured to:
detect a first channel of a plurality of channels for an interconnect that has a greater number of data signals to send than a number of a first set of wires of the interconnect assigned to the first channel;
reassign a second set of wires assigned to a second channel of the plurality of channels to the first channel; and
transmit the data signals for the first channel using the first set of wires and the reassigned second set of wires.

2. The device of claim 1, wherein the control circuit is configured to select the second channel based on an idle status of the second channel.

3. The device of claim 1, wherein the control circuit is configured to select the second channel based on a utilization rate of the second channel being below a low utilization threshold.

4. The device of claim 1, wherein the control circuit is configured to pause transmission on the second channel.

5. The device of claim 4, wherein the control circuit is configured to resume transmission on the second channel by reassigning the second set of wires back to the second channel.

6. The device of claim 4, wherein the control circuit is configured to resume transmission on the second channel by reassigning the first set of wires to the second channel.

7. The device of claim 4, wherein the control circuit is configured to resume transmission on the second channel based on scheduling factors.

8. The device of claim 1, wherein the control circuit is configured to:
reassign a third set of wires assigned to a third channel of the plurality of channels to the first channel; and
transmit the data signals for the first channel using the first set of wires, the reassigned second set of wires, and the reassigned third set of wires.

9. The device of claim 8, wherein the control circuit is configured to select the second and third channels based on a combined utilization rate of the second and third channels being below a low utilization threshold.

10. A system comprising:
a memory; and
a processor comprising:
a first die and a second die;
an interconnect for communicatively coupling the first and second dies, the interconnect including a plurality of wires assigned to a plurality of channels; and
a control circuit configured to:
detect a first channel of the plurality of channels that has a greater number of data signals to send than a number of a first set of wires of the plurality of wires assigned to the first channel;
select a second channel of the plurality of channels based on a utilization rate of the second channel being below a low utilization threshold;
reassign a second set of wires of the plurality of wires assigned to a second channel to the first channel; and
transmit the data signals for the first channel using the first set of wires and the reassigned second set of wires.

11. The system of claim 10, wherein the control circuit is configured to pause transmission on the second channel.

12. The system of claim 11, wherein the control circuit is configured to resume transmission on the second channel by reassigning the second set of wires back to the second channel.

13. The system of claim 11, wherein the control circuit is configured to resume transmission on the second channel by reassigning the first set of wires to the second channel.

14. The system of claim 11, wherein the control circuit is configured to resume transmission on the second channel based on scheduling factors.

15. The system of claim 10, wherein the control circuit is configured to:
reassign a third set of wires of the plurality of wires assigned to a third channel of the plurality of channels to the first channel; and
transmit the data signals for the first channel using the first set of wires, the reassigned second set of wires, and the reassigned third set of wires.

16. The system of claim 15, wherein the control circuit is configured to select the second and third channels based on a combined utilization rate of the second and third channels being below a low utilization threshold.

17. A method comprising:
detecting a first channel of a plurality of channels for an interconnect that has a first utilization rate greater than a high utilization threshold corresponding to a first set of wires of the interconnect assigned to the first channel;
selecting a second channel of the plurality of channels based on a second utilization rate of the second channel being below a low utilization threshold;
pausing transmission on the second channel;
reassigning a second set of wires of the interconnect assigned to the second channel to the first channel; and
transmitting data signals for the first channel using the first set of wires and the reassigned second set of wires.

18. The method of claim 17, further comprising resuming transmission on the second channel by reassigning the second set of wires back to the second channel.

19. The method of claim 17, further comprising resuming transmission on the second channel by reassigning the first set of wires to the second channel.

20. The method of claim 17, further comprising:
selecting the second channel and a third channel of the plurality of channels based on a combined utilization rate of the second and third channels being below a low utilization threshold;
reassigning a third set of wires assigned to a third channel to the first channel; and
transmitting the data signals for the first channel using the first set of wires, the reassigned second set of wires, and the reassigned third set of wires.
